(19) United States
(12) Patent Application Publication
(10) Pub. No.: US 2004/0208946 A1
(43) Pub. Date: Oct. 21, 2004

(54) Tablet press machine

(76) Inventors: Roberto Trebbi, Castenaso (IT); Elvio Gasperini, Castel S Pietro Terme (IT)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/486,837

(22) PCT Filed: Jul. 10, 2003
(86) PCT No.: PCT/IB03/03125

(30) Foreign Application Priority Data
Jul. 15, 2002 (IT) BO2002A000452

(51) Int. Cl. B30B 11/08

(52) U.S. Cl. 425/345; 425/261

(57) ABSTRACT

A tablet press machine (10) of the rotary turret type for the production of pharmaceutical tablets (C) comprises: hopper means (1) for containing pharmaceutical material in powder or granular form to be pressed; rotary disc means (11) equipped with matrices (2) designed to contain defined quantities or doses of the pharmaceutical material fed to them by the hopper means (1); reciprocating punch means for compressing the doses inside the matrices (2). The machine (10) has two tablet (C) outfeed stations (Z1,12;Z2,13) located on the disc mean (11) at a defined angular distance from each other.

### TECHNICAL FIELD

The present invention relates to a tablet press machine.

In particular, the invention relates to a tablet press machine for the production of tablets used in the pharmaceutical field to which the present specification refers but without thereby restricting the scope of the invention.

### BACKGROUND ART

At present, a tablet press machine of the rotary turret type for the production of pharmaceutical tablets essentially comprises a hopper for containing pharmaceutical material in powder or granular form to be pressed, which is fed to a rotary disc having uniformly distributed round its edge a plurality of seats or matrices for forming a defined volumetric quantity or dose of the pharmaceutical material.

The dose of material placed inside each matrix is pressed by a pair of reciprocating punches moving towards and away from the matrix in such a way that the two punches access the matrix simultaneously and compress the dose of material inside it with a predetermined force that gradually increases as the matrix disc rotates and until a finished tablet is formed at the outfeed station of the tablet press machine.

In a tablet press machine of this type, production speed can be increased only by increasing the rotation speed of the matrix disc to very high values.

At these high speeds, however, controlling the drive of the reciprocating punches becomes critical since it is very difficult to control the mechanical parts used to create the increasing compressive force to be applied to the doses of material.

Moreover, the higher the rotation speed of the disc, the higher the risk of breaking the punches or damaging the matrices and, consequently, of having to stop the machine to replace broken or damaged components, which in turn means extended downtime.

The present invention has for an aim to provide a tablet press machine with a high output of pharmaceutical tablets while keeping the rotation speed of the matrix disc down to well-controlled levels.

Another aim of the invention is to provide a tablet press machine having a simple structure with a small number of components.

### DISCLOSURE OF THE INVENTION

Accordingly, the present invention provides a tablet press machine of the rotary turret type for the production of pharmaceutical tablets, comprising: hopper means for containing pharmaceutical material in powder or granular form to be pressed; rotary disc means equipped with matrices designed to contain defined quantities or doses of the pharmaceutical material fed to them by the hopper means; reciprocating punch means for compressing the doses inside the matrices; and a station for feeding the tablets out of the disc means; the machine being characterised in that it comprises a second tablet outfeed station located on the disc means at a defined angular distance from the first outfeed station.

### DESCRIPTION OF THE DRAWINGS

The technical characteristics of the invention, with reference to the above aims, are clearly described in the claims below and its advantages are apparent from the detailed description which follows, with reference to the accompanying drawing which illustrates a preferred embodiment of the invention provided merely by way of example without restricting the scope of the inventive concept, and which represents in a schematic plan view a tablet press machine for the production of pharmaceutical tablets.

### DETAILED DESCRIPTION OF THE PREFERRED EMBODIMENTS OF THE INVENTION

With reference to the accompanying drawing, the numeral 10 denotes a tablet press machine used to manufacture pharmaceutical tablets (C) by compressing a powdered or granular pharmaceutical material according to a customary method.

The tablet press machine 10 is of the rotary turret type, as described, for example, in U.S. Pat. No. 5,698,238, the disclosure of which is incorporated herein by reference, and essentially comprises a hopper 1 for containing the pharmaceutical material in powder or granular form to be compressed, which is gravity fed to a disc 11 which rotates about a vertical axis X and which has uniformly distributed round its edge a plurality of seats or matrices 2, each matrix 2 forming a defined volumetric quantity or dose of the pharmaceutical material inside it.

As is known from the aforementioned U.S. Pat. No. 5,698,238, each matrix 2 is associated with a pair of facing punches (not illustrated), one above and one below, which move in synchronised fashion towards and away from the matrix 2 under the action of customary cam drive means (not illustrated) in such a way as to compress the dose of pharmaceutical material inside the matrix 2 by applying a predetermined compressive force on the dose itself.

According to the method disclosed in the aforementioned U.S. Pat. No. 5,698,238, the compressive force is varied over time in such a way that it increases as the disc 11 rotates about the axis X until the pharmaceutical tablet C is completely formed.

As illustrated in the accompanying drawing, the machine 10 according to the present invention is designed to make tablets C simultaneously on two separate sectors of the rotary disc 11, each corresponding to a complete process cycle within an angle, labelled α, α′, equal to 180°, thus forming two end-of-cycle areas, that is to say, two outfeed stations Z1 and Z2 for the finished tablets C.

In practice, since the tablet press machine 10 has two outfeed stations for the tablets C, it is able to produce twice as many tablets C per unit time as a traditional tablet press machine with a single outfeed station, but without having to increase the angular speed of the matrix disc: thus, the disc 11 of the machine 10 is advantageously made to rotate at a limited angular speed such as to avoid damaging the reciprocating punches moving inside the matrices 2.

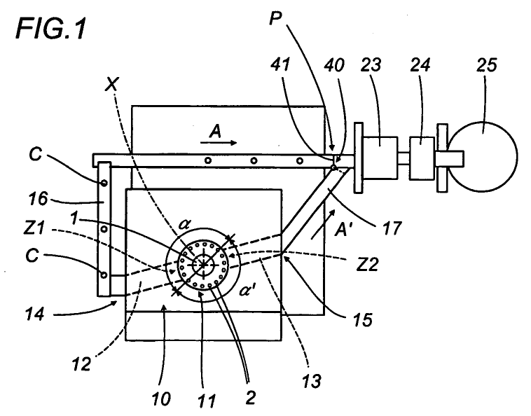

The outfeed stations Z1 and Z2 are located on the disc 11 at diametrically opposite positions and are connected to respective conveyors 12 and 13 (represented by the broken line in FIG. 1) designed to convey the tablets C made by the machine 10 in single file to first and second tablet C outfeed areas 14 and 15, respectively. Each of the outfeed areas 14 and 15 is in turn connected to a respective conveyor 16, 17.

The conveyors 16 and 17 are designed to feed the tablets C made by the machine 10 along separate feed paths A, A′, the path A′ merging with the path A at a confluence area P, where the conveyor 17 joins the conveyor 16. Downstream of the confluence area P, the tablets C from the conveyors 16 and 17 move on the conveyor 16 until they reach further tablet C process stations 23 and 24.

More specifically, the station 23 comprises a de-dusting unit equipped with customary pneumatic components (not illustrated) which clean the tablets C to remove excess particles of pharmaceutical material from them, and the station 24 comprises a metal detector which checks the tablets C for the presence of any metal particles resulting from previous processes, such as, for example, granulation processes which the pharmaceutical material in powder form is usually subjected to before it is fed to the hopper 1 of the machine 10. Any tablets C found by the unit 24 to have residual metal particles in them are rejected by customary rejection means, which are not illustrated.

One advantage of the tablet press machine 10 is that, although it has two outfeed stations, it only has a single de-dusting unit 23 and a single metal detector unit 24 since the outfeed conveyors 16 and 17 are merged into one.

In other words, the confluence of the conveyors 16 and 17 at the area P makes it unnecessary to double the number of components or operating units required downstream of the area P to complete the tablet C production process.

The conveyors 16 and 17 are also equipped with means 40 for synchronising the tablets C fed into the process stations 23 and 24, the means 40 being located and operative at the aforementioned confluence area P.

The synchronising means 40 preferably consist of a flap 41 designed to allow the passage of the tablets C towards the process stations 23 and 24 from the conveyors 16 and 17 alternately.

Downstream of the stations 23 and 24, the tablets C are collected in a container 25.

It will be understood that the present invention can be modified and adapted in several ways for practical application purposes, without thereby departing from the scope of the inventive concept as claimed hereunder.

1. A tablet press machine (10) of the rotary turret type for the production of pharmaceutical tablets (C), comprising: hopper means (1) for containing pharmaceutical material in powder or granular form to be pressed; rotary disc means (11) equipped with matrices (2) designed to contain defined quantities or doses of the pharmaceutical material fed to them by the hopper means (1); reciprocating punch means for compressing the doses inside the matrices (2); and a station (Z1, 14) for feeding the tablets (C) out of the disc means (11); the machine being characterised in that it comprises a second tablet (C) outfeed station (Z2, 15) located on the disc means (11) at a defined angular distance from the first outfeed station (Z1, 14).

2. The tablet press machine according to claim 1, characterised in that the outfeed stations (Z1,14; Z2,15) are located on the disc means (11) at diametrically opposite positions.

3. The tablet press machine according to claim 1 or 2, characterised in that at the outfeed stations (Z1, 14; Z2, 15) of the tablets (C), there are first and second conveyor means (12, 16; 13, 17), which are connected to the outfeed stations (Z1, 14; Z2, 15), respectively, and which are designed to feed the tablets (C) along respective first and second feed paths (A; A′).

4. The tablet press machine according to claim 3, characterised in that the first and second feed paths (A, A′) merge into each other at a confluence area (P), where the second conveyor means (13,17) lead into the first conveyor means (12,16).

5. The tablet press machine according to claim 4, characterised in that, downstream of the confluence area (P), the tablets (C) move along on the first conveyor means until they reach further tablet (C) process stations (23,24); these process stations (23, 24) comprising a station (23) for de-dusting the tablets (C) and a station (24) for detecting any metal particles in the tablets (C).

6. The tablet press machine according to claim 5, characterised in that means (40) are also provided at the confluence area (P) for synchronising the tablets (C) fed into the process stations (23, 24).
